(19) United States
(12) Patent Application Publication
(10) Pub. No.: US 2014/0325862 A1
(43) Pub. Date: Nov. 6, 2014

(54) SCALABLE PILOT DRYER

(71) Applicant: SYNGENTA PARTICIPATIONS AG, Basel (CH)

(72) Inventors: Terrance O'Shea, Slater, IA (US); Mark Melander, Slater, IA (US)

(73) Assignee: SYNGENTA PARTICIPATIONS AG, Basel (CH)

(21) Appl. No.: 14/361,019

(22) PCT Filed: Nov. 28, 2012
(86) PCT No.: PCT/US12/66755

§ 371 Date: May 28, 2014

Related U.S. Application Data
(60) Provisional application No. 61/563,956, filed on Nov. 28, 2011.

(51) Int. Cl. A01F 25/14; F26B 21/10; F26B 21/00

(52) U.S. Cl. CPC A01F 25/14; F26B 21/004; F26B 21/10
USPC 34/89; 34/218

(57) ABSTRACT

The present invention relates generally to testing dryers of crops and, more specifically, to a pilot dryer for ear corn, sunflowers and other field crops that is scalable to adjust to a wide range of desired throughputs and flexible to accommodate drying of a wide range of crops. The apparatus is for drying plant material comprising: an air preconditioning system for producing a processed air supply, a drying bin having first and second end and a bin chamber to operably receive the plant material, said bin forming a part of an airflow pathway; data sensors proximate the bin; air controls; and an airflow pathway operative to transport processed air supply through the plant material within the drying bin in either an up airflow or down airflow direction through the bin, wherein drying the plant material with said processed airflow.

### CROSS-REFERENCE TO RELATED APPLICATION

This application claims benefit under 35 USC 119 to U.S. Provisional Patent Application No. 61/563,956 filed Nov. 28, 2011 which is incorporated herein by reference to the extent not inconsistent herewith.

### BACKGROUND OF THE INVENTION

The present invention relates generally to dryers of crops and, more specifically, to a pilot dryer for ear corn, sunflowers and other field crops that is scalable to adjust to a wide range of desired throughputs and flexible to accommodate drying of a wide range of crops.

Commercial seed companies plant a large number of experimental and pre-commercial plots of distinct varieties. The plots are harvested at maturity and the seed is preserved for possible advancement in the research or commercial programs of the company. It is crucial that seed of each distinct variety be identified and maintained apart from other varieties so that it can be tracked accurately by the seed company. It is also important that the harvested seed, heads and ears be handled and dried in a controlled fashion to maximize the percentage of seed that will be viable for planting and germination in subsequent growing seasons. There is a need, accordingly, for a flexible pilot dryer that can be used in preserving the identity of seed harvested from each distinct variety and is preferably scalable to accommodate a range of throughput volumes.

### SUMMARY OF THE INVENTION

The pilot dryer concept is a flexible, replicated drying platform that includes all aspects of production drying assets. Flexibility includes adaptability to perform drying research on current and new dryer designs, dryer management techniques, seed physiology impact, seed quality impact, and the like.

The design incorporates the ability to modify the ambient drying environment by altering the specific humidity and temperature of the drying air supply. This enables the full range of drying environments experienced in production dryers to be duplicated.

The design is modular so that components of the system can be upgraded or redesigned to adapt to evolving research needs and for the purpose of “shop” fabrication and mobility. The modular design allows the complete dryer to be dismantled and relocated. The dismantled dryer will fit into shipping containers for overseas shipping and is capable of being located and functioning in different geographical locations. With this modular design approach bins can be incrementally added with cost effectively. One or two bins can be added to an existing dryer, or clusters of bins can be added to a site to gain the research capacity needed.

Further, the design is scalable in that various aspects of the design such as the form factor of the bin, the controllable drying environment, bin filling and unloading, and the like is representative of existing production dryers.

The design includes a fully instrumented data collection and control system to facilitate a broad range of drying experiments.

In a preferred embodiment, a six-bin dryer with individual air delivery systems and a common heat delivery system are constructed. The embodiment includes operator access structures, dryer roof, bin fill and shell-out conveyors and operator safety components.

### BRIEF DESCRIPTION OF THE DRAWINGS

FIG. 1 is a plan schematic view of a pilot dryer of the present invention having six dryer modules.

FIG. 2 is a plan schematic view of the site of a pilot dryer of the present invention having 16 dryer modules.

FIG. 3 is a side elevation view of the pilot dryer of FIG. 1.

FIGS. 4A, 4B, and 4C are an enlarged side and plan views of a dryer module bin showing sensor locations and an airflow baffle detail.

FIG. 5 is a schematic diagram showing the instrumentation components of a drying module bin.

FIG. 6 is a schematic view of the airflow in a drying module bin one in down air pass mode.

FIG. 7 is a schematic view of the airflow in a drying module bin in up air pass mode.

FIG. 8 is an elevation view of the pilot dryer.

### DESCRIPTION OF THE INVENTION

The present invention relates to the construction and operation of a pilot dryer including 2-pass and 1-pass ear drying systems. This pilot dryer is useful for dent and sweet corn but it can also be used for a variety of experimental testing with different crops. This dryer can be used for drying or testing of drying or testing of the effects of environmental conditions on maize, oats, hops, buckwheat, grass, flower, rice, wheat, bulgur, millet, rye, soybeans and other beans, melon, pomegranate, sunflower, triticale, barley, canola, cotton, sorghum, safflower, iodized poppy, flowers, vegetables, sesame, cardamom, celery, dill, fennel, nutmeg, and plantain. The invention maximizes dryer throughput while maintaining maximum seed vigor inherent in freshly harvested seed.

The pilot dryer is a flexible, replicated drying platform that will allow drying research on current and new dryer designs, dryer management techniques, seed physiology impact, seed quality impact, and the like. The pilot dryer approximates the performance of a production dryer to a repeatable, uniform and statistical degree that experimental results correlate to and are scalable to production dryers.

The pilot dryer also has functional adaptability and configurability. This includes the ability to perform experiments that facilitate both double pass and single pass dryer configurations, possesses a modular design for adaptability to current and future experiment design requirements, is adaptable to new dryer design innovations, can replicate various ambient drying conditions which affect commercial dryer performance and management and seed quality, has scalable dryer performance for correlation of experimental data to production dryers.

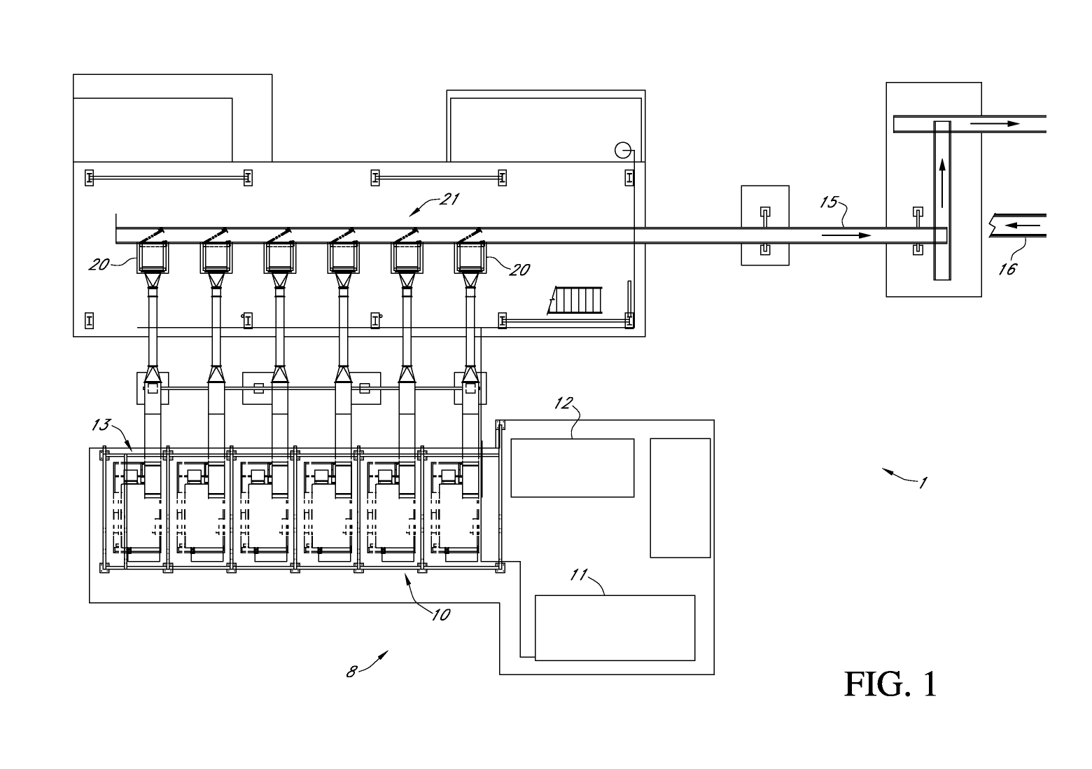

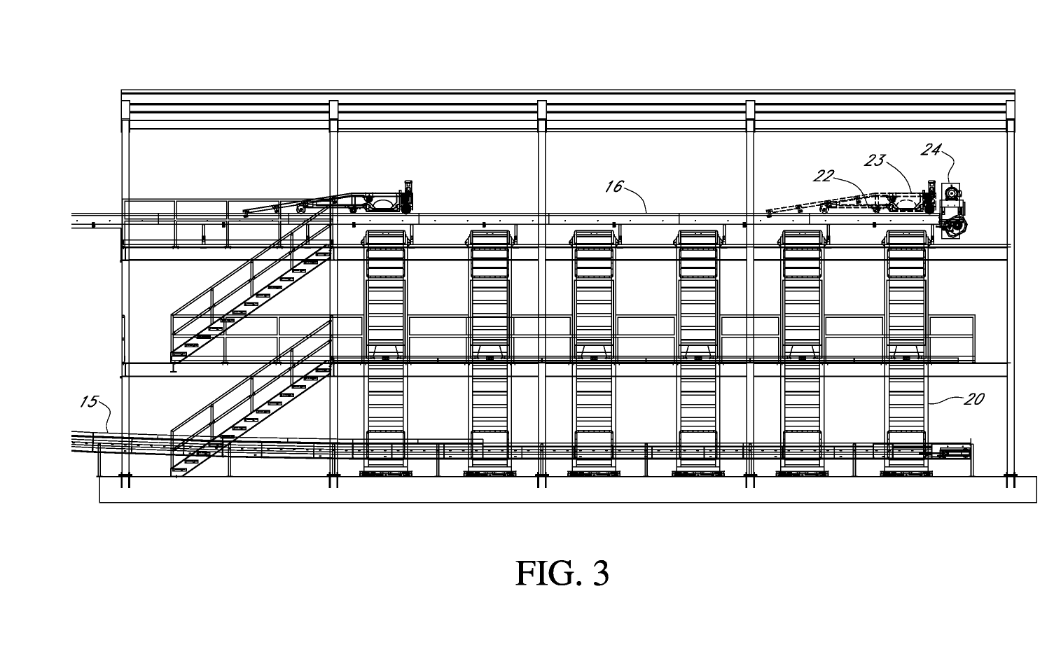

Referring to FIGS. 1-3, the dryer is comprised of multiple independent, ground supported, bins pairs arranged in a single line. An individual bin is capable of single pass reversing operation and pairs of bins are capable of double pass reversing operation. In the preferred embodiment, all bins are identical. Each bin will have separate air delivery, heating and conditioning systems. Each of the bins can also be used to emulate a 2-pass dryer configuration with steam injection into the air delivery system to replicate “up air” conditions. This will allow a 2-bin cluster to operate as 2-pass bins in a replicated trial.

With the modular design, alternative energy modules can be added in the future to test new concepts and fuels.

The dryer is designed for portability and modular to enable it to be “shop built” and assembled in the field and to more conveniently facilitate potential design changes.

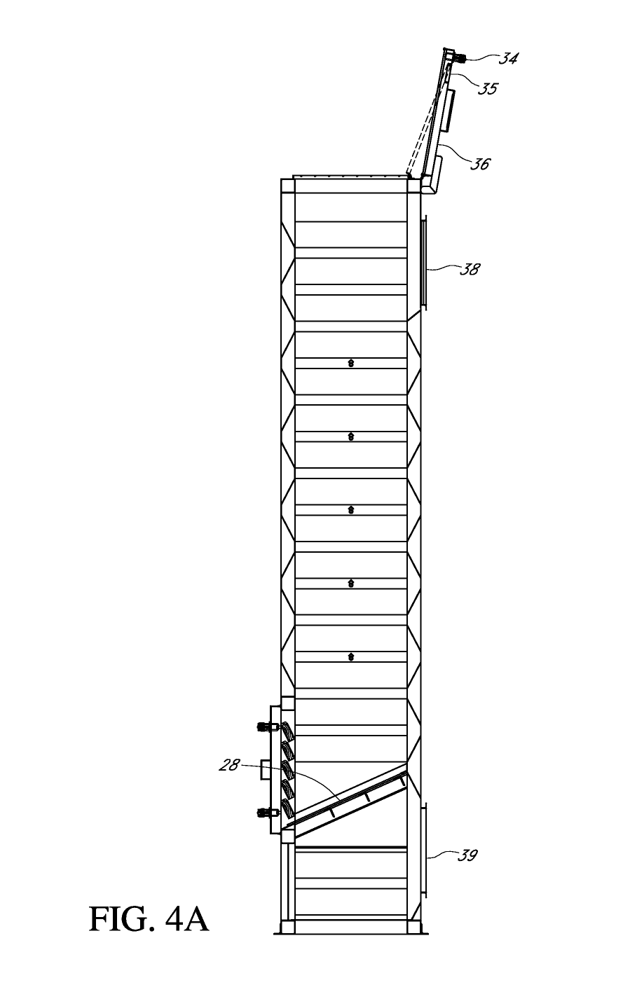

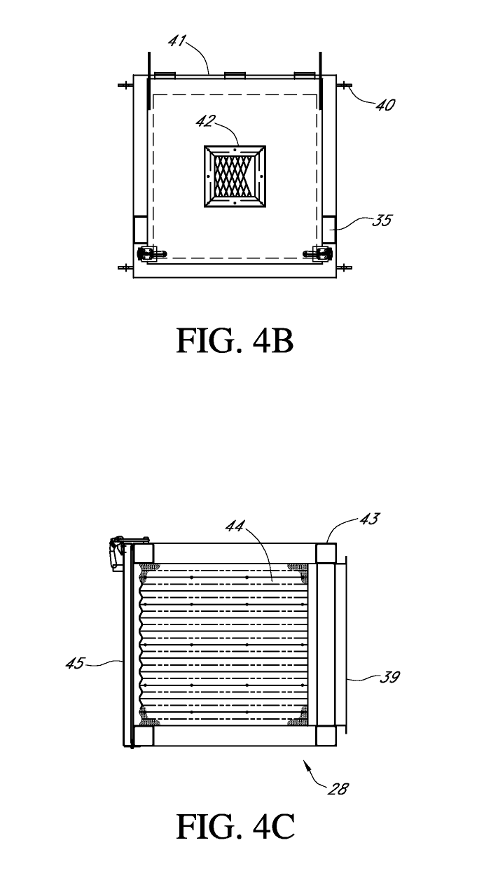

One embodiment, dryer bins are fabricated of steel and have a 3′×3′ cross section and the capability of a 12′ seed depth to emulate commercial ear corn dryers (FIG. 4).

Bin wall panels are designed with a zigzag shape for the purpose of directing the air flow back into the seed pile to prevent excessive air flow along the bin walls where large seeded crops such as ear corn, sunflower heads, and the like meets the smooth bin wall. This is consistent with commercial scale steel dryers. Conditioned air is routed to the bin via a 3′×1½′ directional plenum integrated into the bin design that enables airflow to be directed through the bin in either direction. Seed is loaded into the bin via a hinged loading/exhaust door at the top of the bin. Dried seed is removed by use of an unloading door at the base of the bin floor. An air exhaust door is located beneath the bin floor on the dryer bin bottom for the purpose of arranging bin pairs into a 2-pass configuration. The bin is constructed in sections and the sections bolted together for portability and ongoing design modifications.

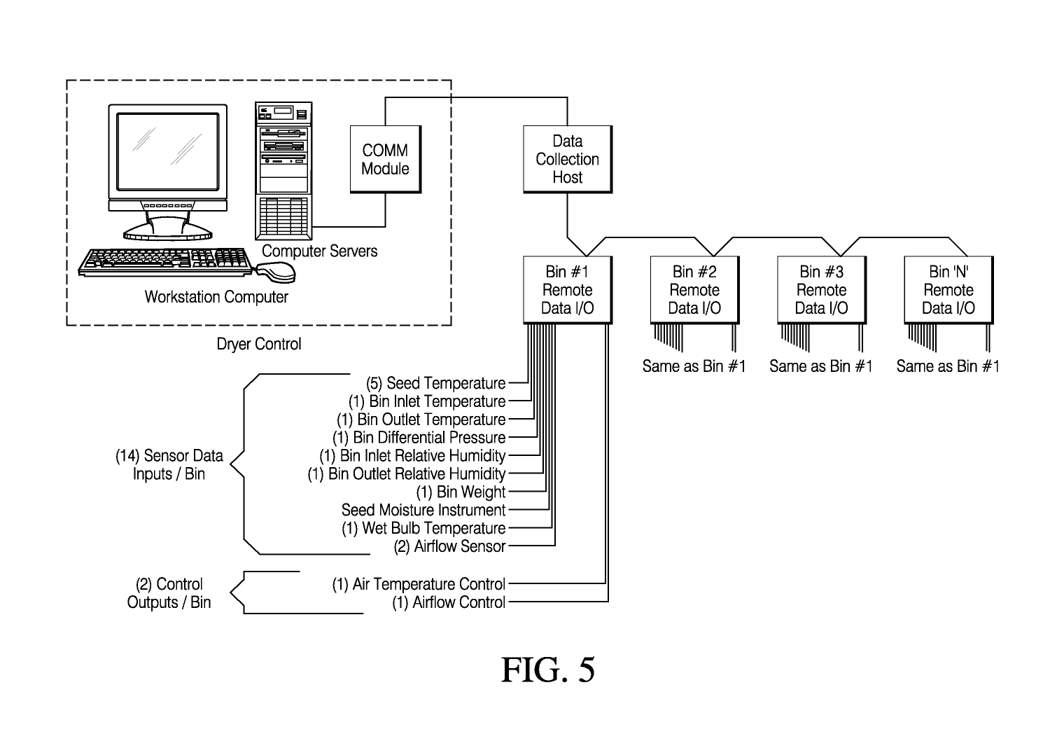

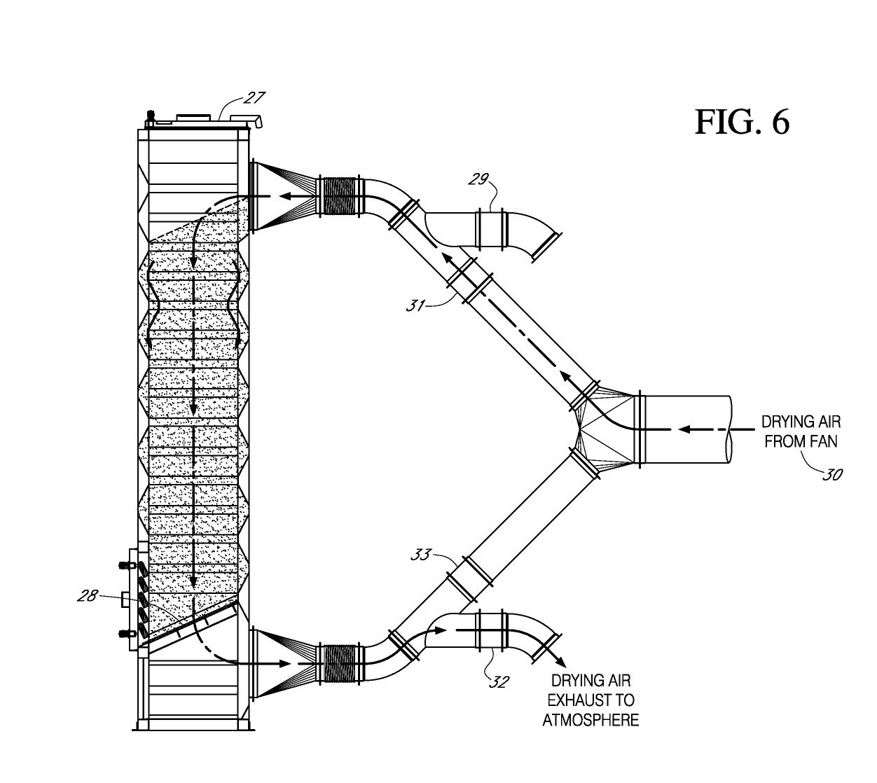

Instrumentation for the bins primarily consists of various sensors that are installed in the bins and dryer in general (FIGS. 4 and 5). They include the following: seed profile temperature—5 single points evenly spaced in seed pile; upper and lower bin temperatures—2 single points; heat exchanger modulation temperatures located at the end of the plenum; differential static pressure 1 single point; humidity—3 single points; bin inlet; bin outlet and main duct; bin weight measuring moisture loss; compression load cells incorporated into bin base structure; (4) load cells summed as a 1 single point; seed profile airflow—2 in the supply ducts; and wet bulb—1 single point. This constitutes 14 points of sensor data for each bin.

The instrumentation also includes a SCADA System primarily consists of the “network” of data collection components that gather and logs the data indicated by the sensors. This system includes the following: operator workstation—Microsoft Windows-based PC (located in dryer control building); PLC based HMI (human machine interface) data collection and control software; (2) graphical user interfaces; drying data presentation, graphing and reporting; historical database; remote, real-time access to HMI screens and data; PLC data collection and control hardware; PLC base unit (located in dryer control building); remote i/o (located in bin areas); scalable system architecture for dryer expansion; remote, “online” access capabilities; operational support and monitoring; technical support.

Air delivery is accomplished via individual fans (FIGS. 1, 2 and 8). Fan motor controls utilize variable frequency drives to allow for adjustable air volume and pressure. Secondary air flow control doors in the air deliver plenum located just prior to the bin directional plenum may be implemented also.

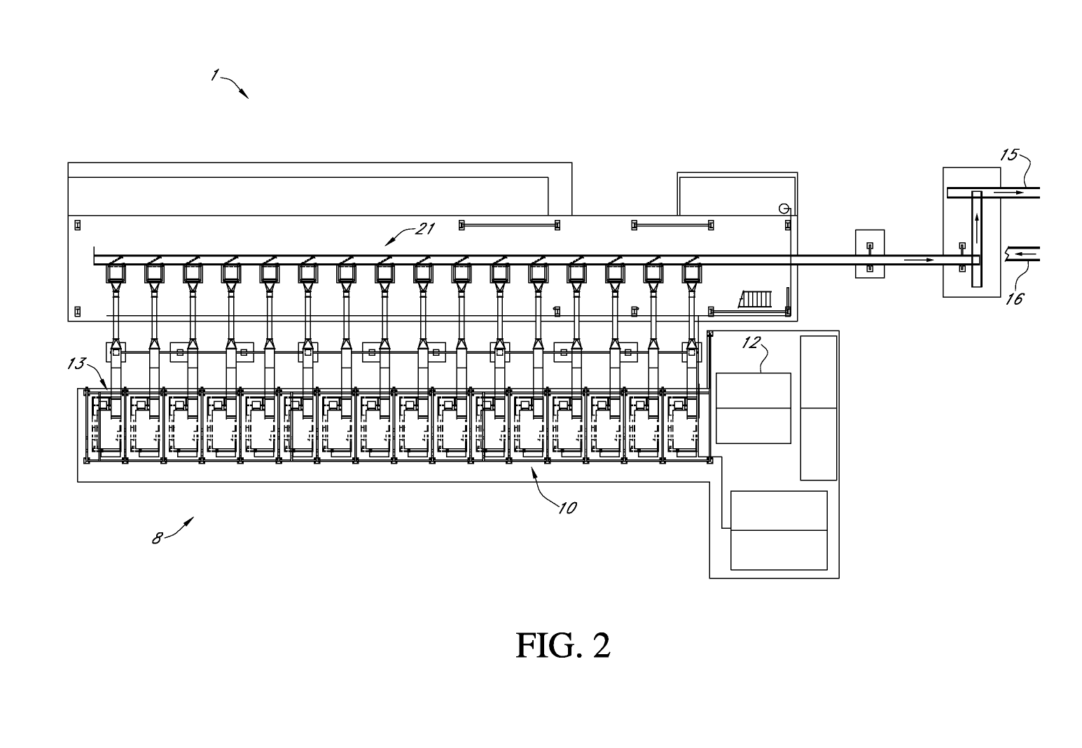

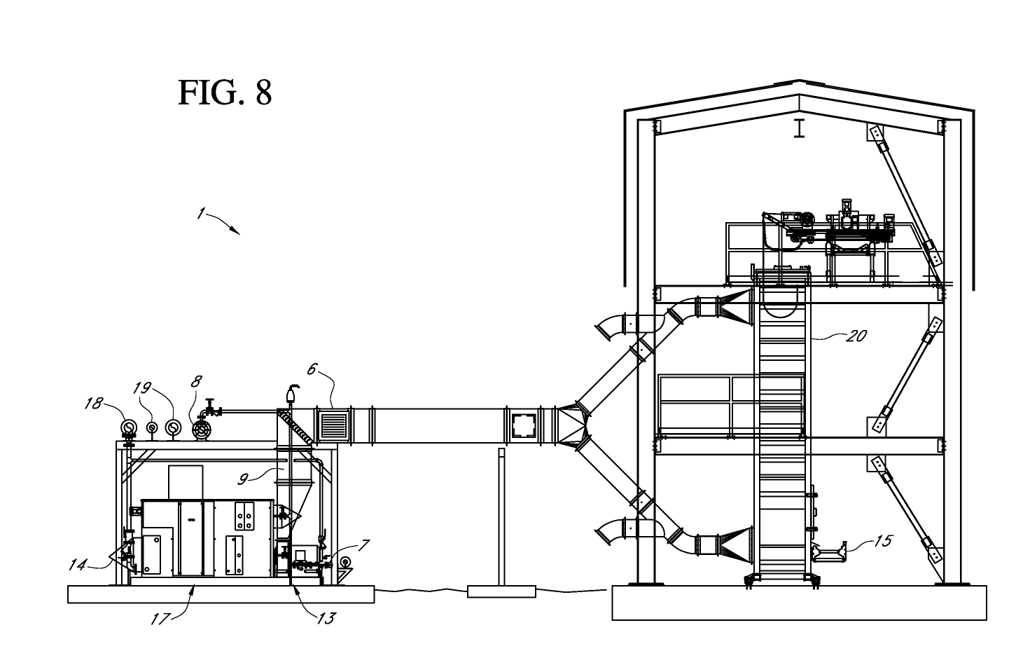

Air heating is accomplished with a common hot water or steam boiler system with individual water-to-air heat exchangers in the air delivery plenum. Temperature will be controlled via modulated control valves in the radiator water supply loops (FIGS. 2 and 8).

Air conditioning consists of altering the ambient air water content by means of refrigeration and desiccation (dehumidification) or humidification (steam injection). This is done for the purpose of simulating different humid (early harvest) or dry (late harvest) ambient drying conditions operations experienced each drying season. A modular steam injection system is used to humidify the incoming air to emulate warm, humid, early harvest ambient conditions to show the effects of slow drying on seed quality and drying periods.

The refrigeration and desiccation system dries the air to simulate fast drying and the affect it has on seed vigor and drying performance. There is a bin loading and unloading belt conveyer common to all bins. The incline loading conveyor is mounted alongside the bins. A cross belt conveyor transfers seed from the incline conveyor to the bins. A let down belt will be added to each bin to reduce mechanical ear damage resulting from excessive fall velocity while filling the bin.

The dryer will provide data that will be used to enhance commercial ear drying operations. The dryer capability specification will be determined based on the level of design, complexity and performance required to be scalable to production dryer operation and to perform the range of experiments needed to conduct a comprehensive spectrum of corn seed drying experiments. The dryer bin design airflow requirements are specified as follows:

MAX Bin Ear Corn Volume=3′×3′×12′=108 ft3 (3.06 m3);
Max Bushel Capacity=108 ft3/3.5 ft3/Bu=31 Shell corn equivalent Bushels (0.84 metric ton); (1.4 MT wet/0.7 MT dry shelled);
Air Volume per Bu=Variable, from 10-80 ft3/min/Bu Static Pressure=2 inch-15 inch Water column (WC); (0.498-3.74 kPa); Max temperature Rise=100° F. (38° C.); Air Volume per Bin=310 ft3/min-2800 ft3/min (790-4758 m3/hr); Air Volume Heat Requirements=maximum 191K Btu/hr/bin/764K Btu/hr/4 bin dryer(3,360 W-13,400 kW). (Assuming a max 70° F. temp rise and 2800 CFM/bin).

One configuration considered was the use of a common air delivery system (i.e. single fan with plenum) as opposed to individual fans for each bin. It was determined that the single fan and plenum approach, while less expensive, significantly limits the flexibility of the dryer. The individual fan per bin design was chosen because it provided a generally more reliable and flexible Airflow design. If a single fan fails only that bin will be lost, while others continue to dry. Also, because dryer bins can more easily be expanded, and because instrumentation can be more easily expanded or changed individual bin/fan modules were developed.

The present invention uses a single fan for each bin capable of 2800 ft3/min air volume with variable motor speed control.

The design of the present invention is such that the operation of the dryer will allow tracking of seed material (both hybrid and inbred seed) through the drying process, as well as cleaning and disposal of seed material.

The present invention broadly teaches an apparatus for drying plant material comprising: a) an air preconditioning system for producing a processed air supply; b) a drying bin having first and second end and a bin chamber to operably receive the plant material, the bin forming a part of an airflow pathway; c). data sensors proximate the bin; d) air controls; and e) an airflow pathway operative to transport processed air supply through the plant material within the drying bin in either an up airflow or down airflow direction through the bin, wherein drying the plant material with the processed airflow. More specifically, the invention has data sensors are for at least one of the following: seed temperature, bin inlet temperature, bin outlet temperature, wet bulb temperatures, bin differential pressure, bin inlet relative humidity, bin outlet relative humidity, bin weight, seed moisture, and airflow.

The drying apparatus has air controls are for altering bin air temperature and airflow. This apparatus also comprises within the airflow pathway, lower bin exhaust gate, a lower bin dryer air gate, an upper bin dryer air gate, and an upper bin exhaust gate. And a processed air supply entrance and a processed air supply exhaust wherein the processed air dries the plant material. This plant material often contains harvest material and seeds, such as maize, oats, hops, buckwheat, grass, flower, rice, wheat, bulgur, millet, rye, soybeans and other beans, melon, pomegranate, sunflower, triticale, barley, canola, cotton, sorghum, safflower, iodized poppy, flowers, vegetables, sesame, cardamom, celery, dill, fennel, nutmeg, or plantain.

This apparatus also is for drying and tracking harvest material. The apparatus comprises a pilot dryer unit with a dryer bin for receiving harvest material from plant varieties, which is scalable to accommodate a range of throughput volumes of harvest material. The apparatus also has an air preconditioning system for producing a processed air supply; and a tracking system for preserving the identity of harvested material from each distinct variety even where there is high throughput volumes of harvested material. The air preconditioning system has a water chiller and a boiler, a steam injection system all for preconditioning the ambient air to form processed air within selected parameters. The apparatus's system of tracking has a computer and a data collection host. This data collection system has a number of experimental variables it can record and depict graphically.

In another embodiment the apparatus comprises one or dryer units operably connected, each to a separate air preconditioning system with a separate airflow pathway separate from other bins' airflow pathways, wherein a number of different processed air parameters can be simultaneously tested in each of the separate dryer bins.

A method of using the apparatus of the present invention includes performing seed drying experiments comprising using a pilot dryer having an air preconditioning system and a replicated drying platform to process different environmental parameters within the bins to evaluate current and new dryer designs, dryer management techniques, seed physiology impact, and seed quality impact.

More specifically, FIG. 1 shows the six individual temperature humidity control units 10 (aka HVAC Skids) which are connected to the boiler system 11 and the chilled water system 12. The temperature humidity control units 10 preconditions the ambient air prior to the airflow entering the pilot dryer bins enclosure 21. Thus the pilot dryer will be able to produce an ambient air environment for a range of experiments-such as a cool, dry day or a hot, humid day.

This lessens the need to enclose the dryer within a refrigerated/heated environment designed to produce a consistent and controllable ambient intake air environment.

A supervisory control and data acquisition station (SCADA) in FIG. 5, controls and or monitors various components shown in FIG. 1 such as the dryer bins 20 and dehumidification system or also referred to as the air preconditioning system 8 which includes at least the temperature humidity control units 10, chiller 12 and boiler 11. The SCADA system also may be used to monitor the status of all connected equipment shown in FIG. 1, including the process air fans 13, the shellout conveyor 15, and the dryer fill conveyor 16 as well as store critical process data to the servers for post experiment analysis. Briefly in operation, the operator of the dryer system 1 shown in FIGS. 1 and 8 can view the ambient conditions such as the current air temperature, relative humidity, dew point and wet bulb temperature on the two graphical interfaces. The system reports real-time on a number subsystems within the dryer system 1 which are the alarms, the air preconditioning system 8 including the temperature humidity control units 10, and its support equipment such as the chiller 12 and steam boiler 11; and the dryer bin system 22 including the dryer fill conveyor 16 and shell out conveyor 15, and the tripper system.

The operator creates an experiment in the “Experiment Set up” screen. Within the experiment setup screen the operator chooses inbred name, scale ticket number, airflow rate, drying air temperatures, dew point, reversal method, dew point additional for 2-pass air drying, combustion air dew point addition from burning hydrocarbons and ramping rates An example of an experiment set up showing a number of parameters that can be used for designing experiments is shown in the table. This was a drying experiment for inbred on the ear harvested corn is shown in Table 1

TABLE 1

| The Experimental set up | Bin 1 | Bin 2 |
|---|---|---|
| Experimental No. | 2 | 2 |
| Material Code | NP2630 | NP4500 |
| Sensitivity | Tolerant | Sensitive |
| Scale Ticket No. | 1 | 2 |
| Harvest Moisture | 46.00% | 46.00% |
| Bin fill Depth | 11.0 Ft | 11.0 FT |
| Dryer type | I pass | I pass |
| Air Flow Control Type | constant fan or | constant fan or |
| | regulated airflow is | regulated airflow |
| | selected | is selected |
| Air Flow Set point | 1243.0 CFM | 1243.0 CFM |
| Ramping Function | Setup | Setup |
| Down Air Temperature set | 105.0 F. | 102.0 F. |
| point | | |
| Up Air Temperature set | 95.0 F. | 90.0 F. |
| point | | |
| Ambient conditions | Mild | Mild |
| 2-pass UP Air Dew point | | |
| offset | | |
| Daily temperature Cycle | Enabled | Enabled |
| Reverse Type | Auto | Auto |
| Auto reverse Type | Delta T | Delta T |
| Predictive Logic (Time) | Enabled | Enabled |

Once the selections are completed, the operator accepts the setup for each of the 6 bins (Table 1 is only showing 2 bins but 6 or more bins can be employed in experiments.); the operator selects “Start HVAC Skid” on the bin view screens. With Start HVAC Skid enabled, the air preconditioning system 8 and its blower fans are started, and the system begins to interact with the main dryer control system. Once the process air fan 13 has reached speed, the conditioned air will be run through the open bypass gate so that the air quality (temperature and dew point) can be established to the experimental set-points before applying the processed air to the seed ear corn. The dehumidifier system 17 (FIG. 8) starts to move the temperature and dew point of the process air towards the respective set points for the experiment. The dehumidifier system has temperature and dew point controllers and electrical actuators for the precooling, post cooling, post heat and reactivation coils.

The SCADA system will notify the operator, when the air quality has stabilized at or near the user-defined range. The SCADA system will also alarm the operator if the temperature or dew point strays out of the approved range for a set length of time.

As shown in FIG. 8 the path of ambient air, chilled water, steam and exhaust through the air preconditioning system 8. The ambient air, moves into the inlet 14 for the ambient air and through an air filter (not shown) and a precooling coil powered by the chiller, which has a chilled water supply 18 and a chilled water return 19.

The pre cooled (pre-dehumidified) air moves through the desiccant dehumidifier 17 and its associated post cool coil and the steam reheat coil to the main process air fans 13. In this embodiment this uses an impregnated silica gel desiccant wheel. The post cooling coil and steam reheat coil in this embodiment uses chiller water and/or steam (respectively) to fine tune the process (drying) air temperature. The steam injection humidifier 9, which in this embodiment uses direct steam injection into the air stream, is powered by a boiler which has a steam supply 8 and condensate return 7. The process air fans 13 which in this embodiment have a variable frequency drive; The fan maintains a consistent CFM (cubic foot per minute) airflow through the dehumidification system for improved control, but is varied through the corn in the bins as per the specific air flow experimental parameters by use of dual modulating louvers. The louvers are controlled by a controller and single actuator. The operator may monitor the temperature, relative humidity and airflow CFM values from the Dew point/Temperature and mass flow meter transmitters beyond the process air fan 13. The air control dampers 6 can have a main air damper, and an air bleed damper. There are different locations and types of damper/louvers arrangements that will work. This invention is not limited to the specific type or location of the damper/louvers shown in the figures. When the system is in a fixed fan speed mode, the system will run the variable frequency drive (VFD) at a fixed speed. Alternatively the system can be run in the regulated airflow mode, where the system will try to maintain a constant airflow by adjusting the damper position. The goal of the air bleed damper is to bleed off air when the variable frequency drive is producing more airflow CFM then desired within the bins. Alternatively, the VFD can alter the fan speed output to effectively alter the drying airflow CFM; this limits the need for the air bleed damper.

The air control dampers 6 is positioned in the air path after the steam injection humidifier 9 which alters the relative humidity of the process air flow as shown in FIG. 8.

The various sensors within the air pathway and the air preconditioning system 8 (FIG. 1) are used with the other data acquiring sensors and other operator entered experimental data to generate reports, graphs and charts indicating such information as the air preconditioning system's airflow and fan speed. Additionally, the all acquired data across the entire system is gathered and stored in the SCADA system historian servers to generate real-time and historical reports and graphs showing data trends, such as the user's experimental configuration information, temperature and wet bulb data, corn weight loss and other controller position data. The drying experiment can be started after the bin is filled, experiment data is entered, pre air condition system is running and the air quality is within specifications. While the air is being preconditioned in air preconditioning system 8 (FIG. 1), the corn can be filed in the dryer bins 20.

When filling a bin 20 with new product identifying data can be input into the computer system, which is shown in FIG. 5, by entry at the SCADA work station directly or remote entry. A scale ticket is configured for the product with a unique scale ticket number, a material code, which can contain the pedigree of the material or a specific material identifier, the date/time the truck was loaded in the field, the field number or a GPS locator, any comments including field conditions, the harvest moisture of the product, the location of the portable dryer and its dryer number and the date/time the truck was received at the plant. Additional information such as the agronomic data associated with the product can be entered. Examples of this information would include insect ratings, disease ratings, plant health ratings and the like. This information uniquely identifies the product throughout the drying and subsequent shelling processes while associating the product with the parameters of the drying experiment it proceeded through.

Dryer bin modes are used to collect data during the different operations of the drying cycle and to run the experiment. The seven dryer bin modes the system identifies are the clean, fill, up air, down air, off air, shelled, and empty. A dryer bin 20, when in the clean mode can be allocated for a new experiment, product code and filled with this uniquely ticketed product.

The product with its scale ticket can be transported from the green corn hopper fill to the dryer bin 20. The dryer has stations to operate the dryer fill conveyor 15 for corn input into the bins and shell out conveyors 16, for dried corn output to the shellers. In the corn dryer bin filling process, the dryer fill conveyer 16 is employed to add material to the dryer bins 20.

FIG. 4 shows the details of the bin which include the over center latch 34, near the lift handle 35 on the opening fill door 36 which covers the opening safety grate 37 on the bin 20. The bin 20 is formed in some embodiments of corrugated side wall sheets with a drying air inlet exhaust port 38 and 39 located proximate the fill door 36 and the floor 28 respectively. The FIG. 4 shows a top view of the dryer bin with the fill door cover with the air seal 41, the center flap vent assembly 42 and lifting hook 40. The top section of the floor sheeting 44 is also shown in this Figure. With the Support frame 43 proximate the shell-out door 45, and the corrugated and perforated floor with holes on staggered centers. The angle of the floor 28 in this embodiment it is 24.2 degrees. A range of 21-24 degrees works, or 20-26 degrees might is also acceptable.

The material such as ear corn is added to the bin generally by being moved by a conveyor from a tote dump to a tripper car 22, which is part of the tripper shuttle assembly 23 that will deposit the corn into the bin. Fill markers can be provided inside the dryer bin so the operator can match the fill depth for the experimental requirements.

The control stations to control the dryer fill conveyors 16 are located at the dryer fill box dump and dryer tripper car 22. The dryer fill conveyor 16 is fed by a box dump station located at the tail end of the conveyor (not shown on FIG. 2).

The conveyor and tripper system are on an emergency stop circuit which will affect all conveyors and tripper car motors. The tripper system has stop systems located in these dryer fill locations: dryer fill conveyor station (near fill hopper not shown), (on tripper car 22), dryer fill let-down belt operator station (on let-down side of the tripper car 22). If the transfer of the product is not interrupted by an emergency stop then the completion of the transfer of the product into the bin places the bin in the fill mode.

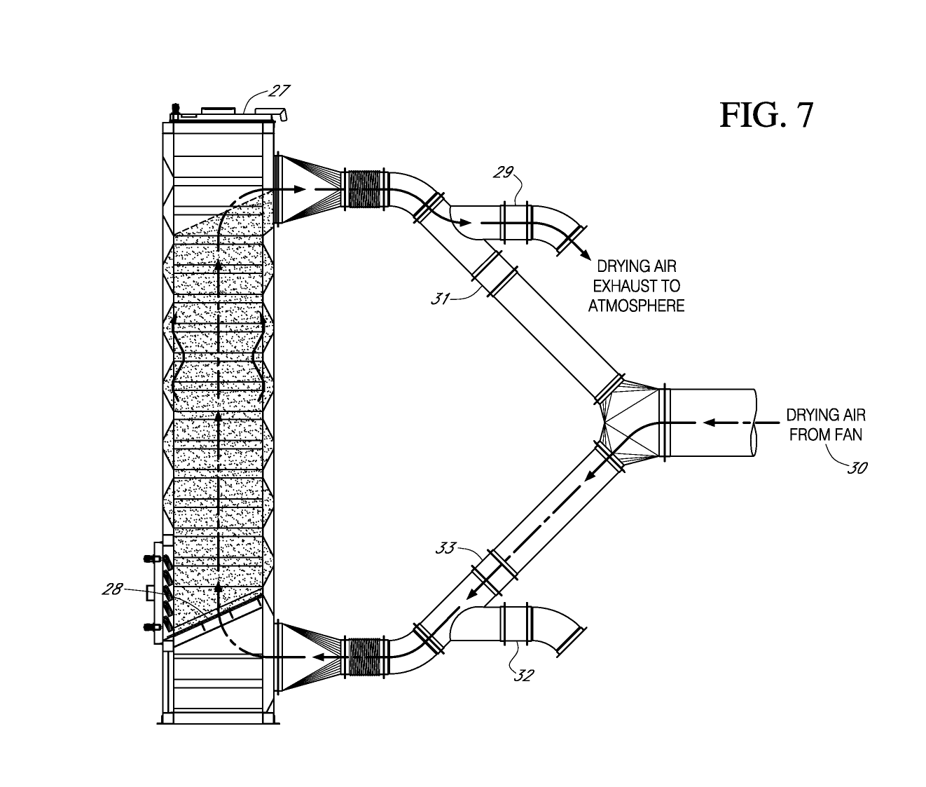

When the dryer bin is filled with the product the up air or down air mode is selected to begin the drying process. Turning to FIG. 7, the airflow in the up air pass is shown. If up air is selected the lower bin exhaust gate 33 opens, the upper bin dryer air gate 29 opens, the upper bin exhaust gate 31 closes and the lower bin dryer air gate 32 closes allowing the preconditioned drying air 30 to flow through the product in the bin. The airflow passes through the corrugated and perforate bin flooring 28 flows up toward the fill door 27 and out to the atmosphere through the upper bin dryer air gate 29. The SCADA system allows multiple up and down air cycles depending on experimental objectives.

If the reverse dryer operation is automatic or selected, the system will change from up air mode to down air mode based on temperature, weight, or time as selected by the operator. The down air mode air pathway is shown in 6 shows when the down air is selected, the upper bin exhaust gate 31 opens, the lower bin dryer air gate 32 opens, the lower bin exhaust gate 33 closes and the upper bin dryer air gate 29 closes. If the reverse operation is automatic, the system will change the air mode based on delta temperature (difference between inlet air and exhaust air through the corn), weight loss, or time as selected.

If the reverse dryer operation is used in an automated function then the operator can set the parameters. These parameters include Delta T—Reversing Temperature Differential, Delta T—Reversing Start Delay, Weight—Reversal Weight and the Time—Predictive Logic. The Delta T—Reversing Temperature Differential will reverse the bin based on the temperature difference between the upper duct temperature and lower duct temperature. The range may be from 0-20 Deg. F. The Delta T—Reversing Start Delay is the delay before the system will check for Delta T. This is a user settable value maybe from 0-24 hours. The Weight—Reversal Weight is the weight at which the bin will reverse. This is an actual weight, the range maybe from 100-1500 KG.

Predictive Logic button will open the predictive logic hours per point table which establishes the expected dry time under the given conditions of pre conditioned air, hybrid/inbred drying characteristics and fill depth. As shown in flow chart of FIG. 5, each individual dryer bin section acquires data that contains bin temperature, weight, airflow data and the Up/Down air elapsed time. Additional data such as bin inlet and outlet temperature, bin differential pressure, bin inlet and outlet humidity, wet bulb temperature, airflow sensors and ambient temperature, dew point and wet bulb acquired data are collected by the 14 sensors and submitted to the SCADA system historian server and through the communication module to the computer to the work station. The controllers use the sensor data inputs to adjust or monitor control outputs/bins such as the air temperature, humidity and airflow control during the drying process.

Upon completion of the drying based on such information as the experimental input parameters, a designated time frame, seed moisture weight loss or the running of predictive dryer logic the bin moves manually or automatically into the Off Air Mode. This mode occurs when the corn in a bin is done drying. If a bin is in off air, then it can be selected for shelling or changed back to up or down air if more drying time is needed.

When drying is complete the bin moves to the shell mode when the corn is being removed from the dryer for shelling purposes. If a bin isn't completely emptied for shelling, it can be put back into Off Air mode to stop the shell mode timer.

The ears of corn are removed from the dryer and transported by the shell out conveyor 15 (FIG. 1) near the shell out doors at the dyer bin and moved to an ear corn box dump (not shown). Hand stations to control the shell out conveyors 15 are located at the dryer shell-out doors and ear corn boxes. The shell-out system has stop systems located in these locations: shell-out conveyor operator station (near shell-out doors at dryer bins 20); shell-out conveyor operator station (near ear corn box dump (not shown); shell-out conveyor cable e-stop (along shell-out conveyor by shell-out bins (not shown).

However, if the bin is emptied, it is placed into the empty mode, cleaned and a new experiment can be created or repeated.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

We claim:

1. An apparatus for drying plant material comprising: a) an air preconditioning system for producing a processed air supply; b) a drying bin having first and second end and a bin chamber to operably receive the plant material, said bin forming a part of an airflow pathway; c). data sensors proximate the bin; d) air controls; and e) an airflow pathway operative to transport processed air supply through the plant material within the drying bin in either an up airflow or down airflow direction through the bin, wherein drying the plant material with said processed airflow.

2. An apparatus according to claim 1 wherein the data sensors are for at least one of the following: seed temperature, bin inlet temperature, bin outlet temperature, wet bulb temperatures, bin differential pressure, bin inlet relative humidity, bin outlet relative humidity, bin weight, seed moisture, and airflow.

3. An apparatus according to claim 1 wherein the air controls are for altering bin air temperature and airflow.

4. An apparatus according to claim 1 comprising lower bin exhaust gate, a lower bin dryer air gate, an upper bin dryer air gate, and an upper bin exhaust gate.

5. An apparatus according to claim 1 wherein the airflow pathway comprises a processed air supply entrance and a processed air supply exhaust.

6. An apparatus according to claim 1 wherein the plant material contains seeds.

7. An apparatus according to claim 6 wherein said seeds are maize, oats, hops, buckwheat, grass, flower, rice, wheat, bulgur, millet, rye, soybeans and other beans, melon, pomegranate, sunflower, triticale, barley, canola, cotton, sorghum, safflower, iodized poppy, flowers, vegetables, sesame, cardamom, celery, dill, fennel, nutmeg, or plantain.

8. Apparatus for drying and tracking harvest material comprising:
1) a pilot dryer unit with a dryer bin for receiving harvest material from plant varieties, and which is scalable to accommodate a range of throughput volumes of harvest material;
2) an air preconditioning system for producing a processed air supply; and,
3) a tracking system for preserving high throughput volumes of the identity of high throughput volumes of harvested material from each distinct variety.

9. An apparatus according to claim 8 wherein the air preconditioning system has a water chiller and a boiler for preconditioning the ambient air to form processed air within selected parameters.

10. An apparatus according to claim 8 where in the apparatus comprises a system of tracking that includes a computer and a data collection host.

11. An apparatus according to claim 8 where in the apparatus comprises one or more dryer units operably connected each to a separate air preconditioning system with a separate airflow pathway from other bins, wherein a number of different processed air parameters can be simultaneously tested in each of the separate dryer bins.

12. A method of performing seed drying experiments comprising using a pilot dryer having an air preconditioning system and a replicated drying platform to process different environmental parameters within the bin to test current and new dryer designs, dryer management techniques, seed physiology impact, and seed quality impact.
